(19) United States
(12) Patent Application Publication
(10) Pub. No.: US 2012/0079824 A1
(43) Pub. Date: Apr. 5, 2012

(54) SYSTEM FOR CORRECTING TURBO LAG

(75) Inventors: Jin Wook Son, Suwon-si (KR); Jei Choon Yang, Yongin-si (KR); Won Seok Chang, Ansan-si (KR); Jeong Hwa Cha, Incheon-si (KR); Jin Kook Kong, Suwon-si (KR); Soo Hyung Woo, Yongin-si (KR); Young Nam Kim, Seongnam-si (KR); Jin Soon Kim, Hwaseong-si (KR)

(73) Assignee: Hyundai Motor Company, Seoul (KR)

(21) Appl. No.: 13/170,917

(22) Filed: Jun. 28, 2011

(30) Foreign Application Priority Data
Sep. 30, 2010 (KR) 10-2010-0095557

(51) Int. Cl. F02D 23/00

(52) U.S. Cl. 60/602

(57) ABSTRACT

A system for correcting turbo lag may include an engine provided with a plurality of cylinders, an intake manifold for supplying air to the plurality of cylinders, and an exhaust manifold for exhausting exhaust gas generated in the plurality of cylinders, an intake passage connected to the intake manifold so as to supply fresh air to the intake manifold, an exhaust passage connected to the exhaust manifold so as to exhaust the exhaust gas gathered in the exhaust manifold, a turbo charger provided with a turbine mounted at the exhaust manifold or the exhaust passage and rotated by the exhaust gas and a first compressor mounted at the intake passage and connected to the turbine so as to rotate with the turbine and compress the air of the intake passage, a bypass passage branching off at a first point of the intake passage and joining the intake passage at a second point of the intake passage downstream of the first point, a second compressor mounted at the bypass passage and compressing the air passing through the bypass passage, and driving means generating power for operating the second compressor and selectively supplying the power to the second compressor through a power delivery device.

### CROSS-REFERENCE TO RELATED APPLICATION

The present application claims priority of Korean Patent Application Number 10-2010-0095557 filed Sep. 30, 2010, the entire contents of which application is incorporated herein for all purposes by this reference.

### BACKGROUND OF INVENTION

1. Field of Invention

The present invention relates to a system for correcting turbo lag. More particularly, the present invention relates to a system for correcting turbo lag that improves acceleration performance by increasing air amount supplied to an engine within a turbo lag region.

2. Description of Related Art

Generally, an engine must take in as much air mixture as the exhaust gas amount, but it can actually take in only 80% of the exhaust gas amount. The amount of power an engine produces is proportional to the amount of airflow, and the number of valves may be increased or the diameter of the valves may be enlarged in order to increase the air intake amount. In addition, air may be forcibly blown in by a turbo charger in order to increase air intake amount.

Generally, a turbo charge system increases the air intake amount input to an intake manifold by using a turbo charger connected to the intake manifold and an exhaust manifold. More concretely, in a case in which a turbine of the turbo charger is forcibly rotated by exhaust gas having passed through the exhaust manifold, a compressor connected to the turbine rotates and forcibly blows air into the intake manifold. According to the turbo charge system, the high temperature and pressure exhaust gas passes through the turbine and its temperature and pressure are lowered. Therefore, energy of the exhaust gas is transmitted to the turbine and the turbine is rotated.

In a case that such a turbo charge system is applied to a vehicle, turbo lag occurs necessarily. The turbo lag means that target acceleration performance cannot be achieved during a period for which turbine speed of the turbo charger reaches target speed when acceleration. The turbo lag mainly occurs when the vehicle runs with a low speed. Particularly, in a case that the turbo charger is applied to a small engine having small displacement, fuel economy may improve but the turbo lag may be serious at a low speed region. Therefore, it is very difficult to apply the turbo charger to the small engine having small displacement.

It is disclosed in U.S. Pat. No. 7,028,677 that air supply is increased by rotating an impeller connected to a drive source through a belt and a tensioner is mounted at the belt for smooth power delivery. However, since a crankshaft of an engine is used as the drive source according to disclosures of U.S. Pat. No. 7,028,677, occurrence of the turbo lag may not be prevented if an engine speed is low. In order to solve such a problem, speed-increasing means are disposed between the crankshaft and the impeller. In this case, power delivery performance and durability of the belt may be deteriorated if the engine speed is high. In addition, power of the engine more than needed may be used and fuel economy may be deteriorated.

It is disclosed in Japanese Patent Laid-Open Publication No. H2-119623 that a turbo charger and a mechanical supercharger is disposed in series, and the mechanical supercharger is used as an expander for recovering power in a case that exhaust pressure of the turbo charger is higher than that of the mechanical supercharger in a state that the engine speed is high. However, since the turbo charger and the mechanical supercharger are disposed in series according to disclosures of Japanese Patent Laid-Open Publication No. H2-119623, flow of an air may be hindered in a case that the mechanical supercharger is not operated. In addition, power delivery performance and durability of the belt may be deteriorated if the engine speed is high. In addition, power of the engine more than needed may be used and the air may be excessively supplied. Therefore, fuel economy may be deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a system for correcting turbo lag having advantages of reducing power loss and improving acceleration performance as a consequence that an additional compressor is disposed in parallel with a turbo charger and the additional compressor is operated only within a turbo lag region.

A system for correcting turbo lag according to various aspects of the present invention may include an engine provided with a plurality of cylinders, an intake manifold for supplying air to the plurality of cylinders, and an exhaust manifold for exhausting exhaust gas generated in the plurality of cylinders, an intake passage connected to the intake manifold so as to supply fresh air to the intake manifold, an exhaust passage connected to the exhaust manifold so as to exhaust the exhaust gas gathered in the exhaust manifold, a turbo charger provided with a turbine mounted at the exhaust manifold or the exhaust passage and rotated by the exhaust gas and a first compressor mounted at the intake passage and connected to the turbine so as to rotate with the turbine and compress the air of the intake passage, a bypass passage branching off at a first point of the intake passage and joining the intake passage at a second point of the intake passage downstream of the first point, a second compressor mounted at the bypass passage and compressing the air passing through the bypass passage, and driving means generating power for operating the second compressor and selectively supplying the power to the second compressor through a power delivery device.

The power delivery device may include a plurality of pulleys and at least one of belts and shafts connecting each pulley to the second compressor, the driving means, or other pulley.

The second compressor may be operated at a predetermined turbo lag region.

The control valve may open or close automatically by a difference between air pressure of the intake passage and air pressure of the bypass passage near a mounting portion thereof.

The belt may be a flat belt.

A cooling apparatus for cooling the air may be mounted at the intake passage downstream of the turbo charger.

According to other aspects of the present invention, the first point and the second point may be positioned at the intake passage upstream of the turbo charger.

According to various aspects of the present invention, the driving means may include a crankshaft pulley mounted at a crankshaft of the engine and rotating with the crankshaft, a driving pulley connected to the crankshaft pulley through a driving belt, and a clutch selectively connecting the power delivery device to the driving pulley so as to selectively transmit the power of the driving means.

According to other aspects of the present invention, the driving means may be a motor connected to the power delivery device and selectively generating the power supplied to the second compressor.

According to still further aspects of the present invention, the first point may be positioned at the intake passage upstream of the turbo charger and the second point may be positioned between the turbo charger of the intake passage and the cooling apparatus.

According to other aspects of the present invention, the driving means may include a crankshaft pulley mounted at a crankshaft of the engine and rotating with the crankshaft, a driving pulley connected to the crankshaft pulley through a driving belt, and a clutch selectively connecting the power delivery device to the driving pulley so as to selectively transmit the power of the driving means.

According to further aspects of the present invention, the driving means may be a motor connected to the power delivery device and selectively generating the power supplied to the second compressor.

According to further still aspects of the present invention, the first point and the second point may be positioned between the turbo charger at the intake passage and the cooling apparatus.

According to other aspects of the present invention, the driving means may include a crankshaft pulley mounted at a crankshaft of the engine and rotating with the crankshaft, a driving pulley connected to the crankshaft pulley through a driving belt, and a clutch selectively connecting the power delivery device to the driving pulley so as to selectively transmit the power of the driving means.

According to various aspects of the present invention, the driving means may be a motor connected to the power delivery device and selectively generating the power supplied to the second compressor.

According to various aspects of the present invention, the first point and the second point may be positioned at the intake passage downstream of the cooling apparatus.

According to various aspects of the present invention, the driving means may include a crankshaft pulley mounted at a crankshaft of the engine and rotating with the crankshaft, a driving pulley connected to the crankshaft pulley through a driving belt, and a clutch selectively connecting the power delivery device to the driving pulley so as to selectively transmit the power of the driving means.

According to various aspects of the present invention, the driving means may be a motor connected to the power delivery device and selectively generating the power supplied to the second compressor.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an exemplary system for correcting turbo lag according to the present invention.

FIG. 2 is a schematic diagram showing an example of a power delivery device used in an exemplary system for correcting turbo lag according to the present invention.

FIG. 3 is a schematic diagram showing another example of a power delivery device used in an exemplary system for correcting turbo lag according to the present invention.

FIG. 4 is a block diagram showing a control portion controlling an exemplary system for correcting turbo lag according to the present invention.

FIG. 5 is a graph showing turbo lag region at which a system for correcting turbo lag according to the present invention may be operated.

FIG. 6 is a schematic diagram showing an exemplary system for correcting turbo lag shown in FIG. 1 is operated.

FIG. 7 is a schematic diagram of an exemplary system for correcting turbo lag according to another exemplary embodiment of the present invention.

FIG. 8 is a schematic diagram showing an exemplary system for correcting turbo lag shown in FIG. 7 is operated.

FIG. 9 is a schematic diagram of another exemplary system for correcting turbo lag according to the present invention.

FIG. 10 is a schematic diagram showing an exemplary system for correcting turbo lag shown in FIG. 9 is operated.

FIG. 11 is a schematic diagram of another exemplary system for correcting turbo lag according to the present invention.

FIG. 12 is a schematic diagram showing an exemplary system for correcting turbo lag shown in FIG. 11 is operated.

FIG. 13 is a schematic diagram of another exemplary system for correcting turbo lag according to the present invention.

FIG. 14 is a schematic diagram an exemplary system for correcting turbo lag shown in FIG. 13 is operated.

FIG. 15 is a schematic diagram of another exemplary system for correcting turbo lag according to the present invention.

FIG. 16 is a schematic diagram showing an exemplary system for correcting turbo lag shown in FIG. 15 is operated.

FIG. 17 is a schematic diagram of another exemplary system for correcting turbo lag according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

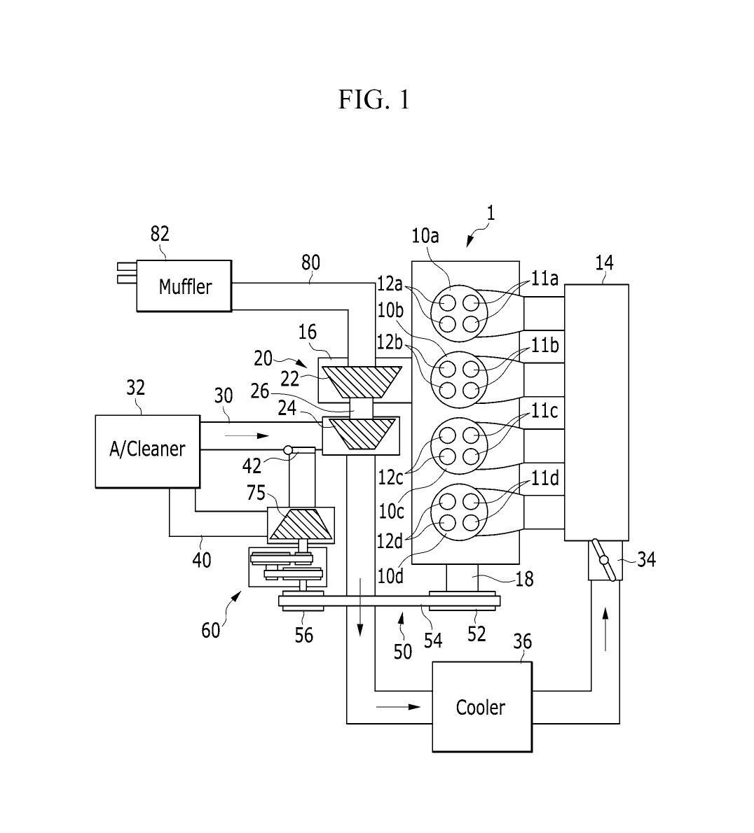

FIG. 1 is a schematic diagram of a system for correcting turbo lag according to the present invention.

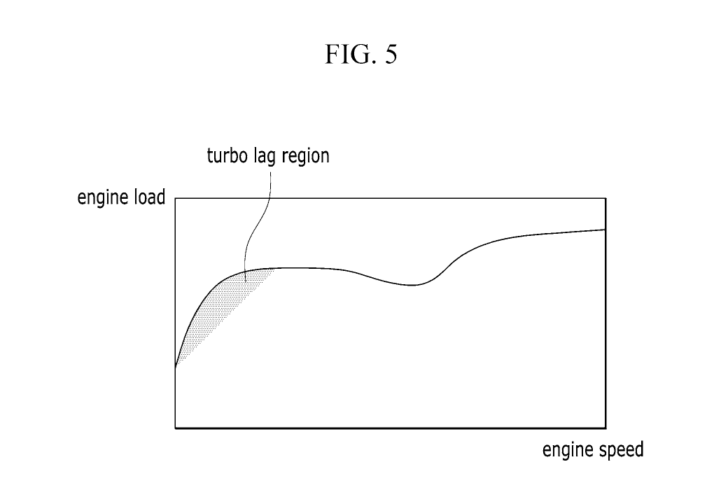

As shown in FIG. 1, a system for correcting turbo lag according to various embodiments of the present invention increases air amount supplied to an engine 1 within a turbo lag region. Herein, the turbo lag region means a region at which turbo lag occurs, and, as shown in FIG. 5, is predetermined according to an engine speed and an engine load. Generally, the turbo lag mainly occurs when a vehicle accelerates at a low speed region.

The engine 1 burns an air and a fuel so as to generate power, and the burned air and fuel (i.e., exhaust gas) are exhaust to the exterior of the vehicle. For this purpose, the engine 1 includes a plurality of cylinders 10a, 10b, 10c, and 10d, an intake manifold 14, and an exhaust manifold 16. The system for correcting turbo lag includes an intake passage 30 for supplying the air to the engine 1, an exhaust passage 80 for exhausting the exhaust gas generated in the engine 1 to the exterior of the vehicle, and a bypass passage 40 branching off at a first point of the intake passage 30 and joining the intake passage 30 at a second point of the intake passage 30 downstream of the first point.

Pistons are disposed respectively in the plurality of cylinders 10a, 10b, 10c, and 10d, and a combustion chamber is formed between an upper end of the piston and the cylinder. In addition, intake ports 11a, 11b, 11c, and 11d which open or close by an intake valve and supplies the air and/or the fuel to the combustion chamber and exhaust ports 12a, 12b, 12c, and 12d which open or close by an exhaust valve and exhausts the exhaust gas generated in the combustion chamber to the exterior of the combustion chamber are formed above each cylinder 10a, 10b, 10c, and 10d. In addition, a spark plug, an injector, and such are mounted above each cylinder 10a, 10b, 10c, and 10d. The piston is connected to a crankshaft 18 through a connecting rod and rotates the crankshaft 18 by combustion force of air-fuel mixture.

The intake manifold 14 is connected to the intake ports 11a, 11b, 11c, and 11d so as to supply the air and/or the fuel to the combustion chamber, and the exhaust manifold 16 is connected to the exhaust ports 12a, 12b, 12c, and 12d so as to gather the exhaust gas generated in the combustion chamber.

The intake passage 30 means all the passages through which the exterior air flows to the intake manifold 14 of the engine 1. An air cleaner 32 is mounted upstream of the intake passage 30 and removes foreign matters contained in the exterior air. In addition, a cooling apparatus 36 is mounted at the intake passage 30 and cools the air. Since density of the air is lowered, the more air can be supplied to the intake manifold 14. In addition, a throttle valve 34 operated by an accelerator pedal is mounted at the intake passage 30 and controls intake amount.

The exhaust passage 80 means all the passages through which the exhaust gas gathered in the exhaust manifold 16 flows out to the exterior of the vehicle. A muffler 82 is mounted at the exhaust passage 80 and reduces noise of the exhaust gas. As occasion demand, catalytic means may be mounted at the exhaust passage 80 and remove harmful substance contained in the exhaust gas.

As described above, the bypass passage 40 branches off from the intake passage 30 and joins to the intake passage 30 again. A control valve 42 is mounted at a branching point (the first point) of the intake passage 30 and the bypass passage 40 or a joining point (the second point) of the intake passage 30 and the bypass passage 40. The control valve 42 controls the air passing through the air cleaner 32 to flow to the intake manifold 14 only through the intake passage 30 or through the intake passage 30 after passing through the bypass passage 40. That is, the control valve 42 selectively communicates the bypass passage 40 to the intake passage 30. Such the control valve 42 may be automatically operated by a difference between air pressure of the intake passage 30 and air pressure of the bypass passage 40 at the first point or the second point or may be operated by electric signals of a control portion 120.

The system for correcting turbo lag according to various embodiments of the present invention includes a turbo charger 20. The turbo charger 20 increases air amount supplied to the engine 1 by using exhaust heat of the exhaust gas. Such the turbo charger 20 includes a turbine 22 mounted at the exhaust manifold 16 or the exhaust passage 80 and rotated by the exhaust gas and a first compressor 24 mounted at the intake passage 30 and fixed to the turbine 22 through a first shaft 26 so as to rotate with the turbine 22. If the turbine 22 is rotated by the exhaust gas, the first compressor 24 also rotates and compresses the air. Therefore, the air amount supplied to the engine 1 is increased.

The system for correcting turbo lag according to various embodiments of the present invention further includes driving means 50, a power delivery device 60, and a second compressor 75.

The driving means 50 generates power for operating the second compressor 75. According to various embodiments of the present invention, the driving means 50 include a crankshaft pulley 52, a driving pulley 56, a driving belt 54, and a clutch 58.

The crankshaft pulley 52 is fixedly mounted to the crankshaft 18 and rotates with the crankshaft 18.

The driving pulley 56 connected to the crankshaft pulley 52 through the driving belt 54 and rotates with the crankshaft pulley 52.

The clutch 58 selectively transmits power of the driving pulley 56 to the power delivery device 60. That is, the power of the driving pulley 56 is transmitted to a power delivery device 60 if the clutch 58 operates, and the power of the driving pulley 56 is not transmitted to the power delivery device if the clutch 58 does not operate. Various clutches such as electric clutches and hydraulic pressure clutches may be used as the clutch 58. The clutch 58 is well known to a person of an ordinary skill in the art, and detailed description thereof will be omitted.

The power delivery device 60 transmits the power generated by the driving means 50 to the second compressor 75, and includes a plurality of shafts 62, 66, and 71, a plurality of pulleys 61, 63, 67, and 69, and a plurality of belts 64 and 68. Some examples of the power delivery device 60 is described in this specification, and the scope of the present invention is not limited to this.

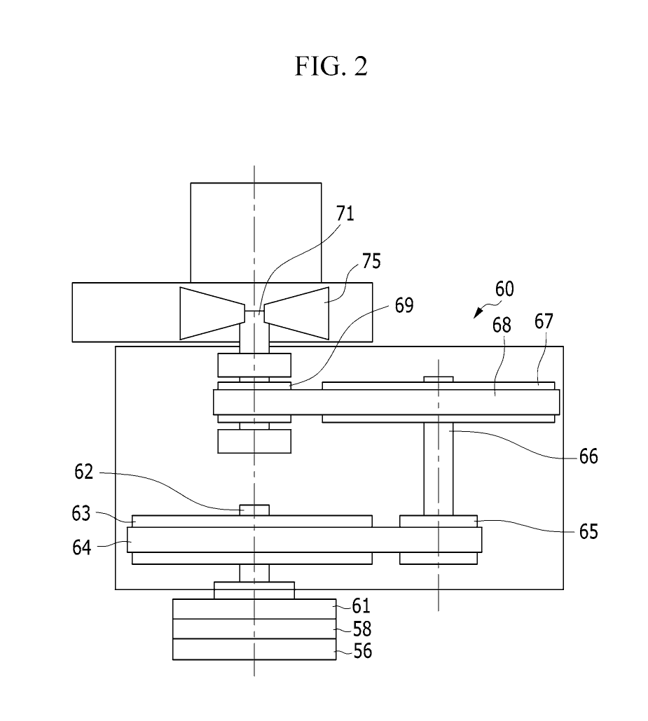

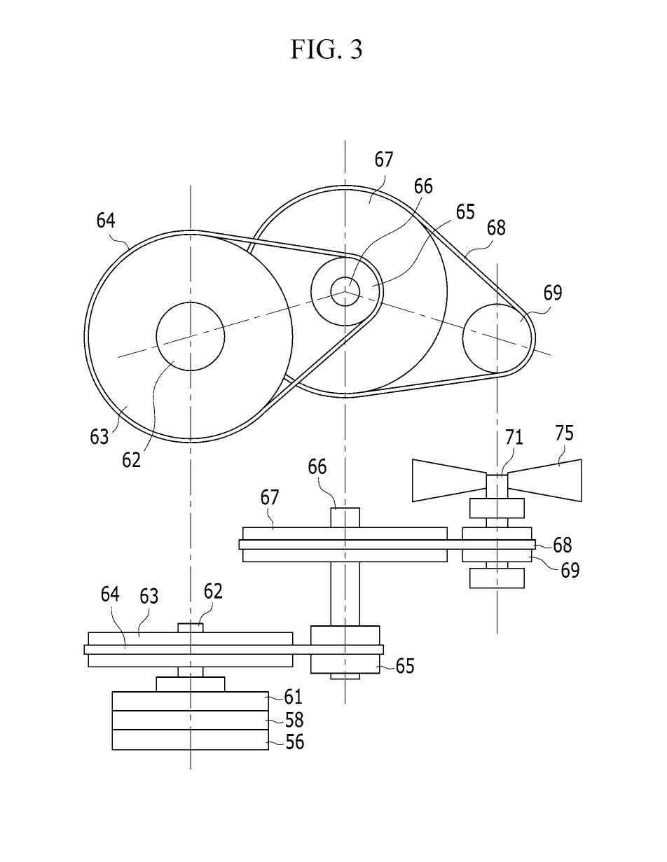

As shown in FIG. 2 and FIG. 3, the first pulley 61 is selectively connected to the driving pulley 56 through the clutch 58. In addition, the first pulley 61 is fixed to the second shaft 62.

The second pulley 63 is fixed to the second shaft 62 and rotates with the same speed as the first pulley 61.

The third pulley 65 is connected to the second pulley 63 through the first belt 64. The third pulley 65 is fixed to the third shaft 66.

The fourth pulley 67 is fixed to the third shaft 66 and rotates with the same speed as the third pulley 65.

The fifth pulley 69 is connected to the fourth pulley 67 through the second belt 68. The fifth pulley 69 is fixed to the fourth shaft.

Meanwhile, since rotation speed of the crankshaft 18 is slow at the turbo lag region, the power delivery device 60 should increase speed so as to increase air supply. For this purpose, the pulleys connected to each other through the belt have different diameters. For example, a diameter of the crankshaft pulley 52 is larger than that of the driving pulley 56, a diameter of the second pulley 63 is larger than that of the third pulley 65, and a diameter of the fourth pulley 67 is larger than that of the fifth pulley 69.

In addition, since the power delivery device 60 increases rotation speeds of the pulleys, the belts connecting the pulleys can transmit high-speed power. If a cog belt is used, noise is loud and high-speed power cannot be transmitted. If a V-belt is used, thickness thereof should be thicker and high-speed power cannot be transmitted. Therefore, a thin flat belt is used in various embodiments of the present invention so as to enhance delivery efficiency of high-speed power.

The second compressor 75 is mounted at the bypass passage 40 and is fixed to the fourth shaft 71. The second compressor 75 is rotated by the power transmitted from the power delivery device 60 and compresses the air so as to increase air supply to the intake manifold 14.

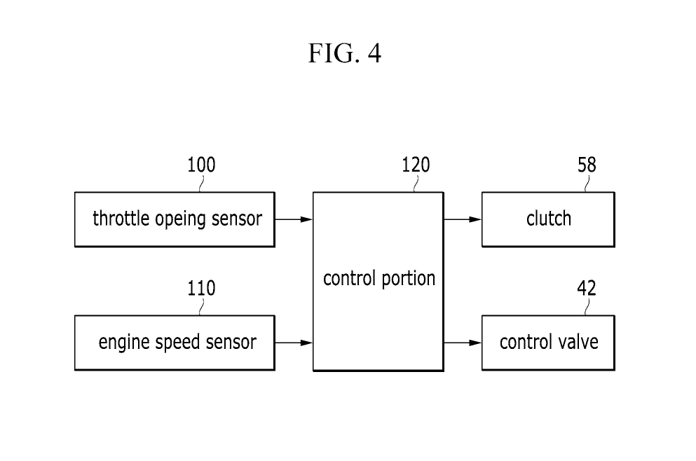

FIG. 4 is a block diagram showing a control portion controlling a system for correcting turbo lag according to various embodiments of the present invention.

As shown in FIG. 4, a system for correcting turbo lag according to various embodiments of the present invention further includes a throttle opening sensor 100, an engine speed sensor 110, and the control portion 120.

The throttle opening sensor 100 detects an opening of the throttle valve 34 operated by the accelerator pedal, and transmits a signal corresponding thereto to the control portion 120. Herein, the opening of the throttle valve 34 corresponds to the engine load.

The engine speed sensor 110 detects a rotation speed of the crankshaft 18 from a phase change of the crankshaft 18, and transmits a signal corresponding thereto to the control portion 120.

The control portion 120 is connected to the throttle opening sensor 100 and the engine speed sensor 110, receives signals corresponding to the opening of the throttle valve 34 and the engine speed, and determines whether a driving condition of the engine is the turbo lag region based thereon. If the driving condition of the engine is the turbo lag region, the control portion 120 controls the clutch 58, the motor 50′, or the control valve 42. It is exemplified in this specification that the control valve 42 opens or closes automatically by the pressure difference, but the scope of the present invention is not limited to this. That is, when the control portion 120 controls the clutch 58 or the motor 50′, the control portion 120 may also operate the control valve 42.

Hereinafter, an operation of the system for correcting turbo lag according to various embodiments of the present invention will be described in detail. In the system for correcting turbo lag according to various embodiments of the present invention, the first point and the second point are positioned at the intake passage 30 upstream of the turbo charger 20 (the first compressor 24). In addition, the control valve 42 is disposed at the second point.

As shown in FIG. 1, when the engine 1 operates at a normal state (i.e., region which is not the turbo lag region), the control portion 120 controls the clutch 58 so as to disconnect the power delivery device 60 from the driving means 50. In addition, the control portion 120 controls the control valve 42 so as to block the bypass passage 40. In this case, since the bypass passage 40 is blocked, the air passing through the air cleaner 32 is pressurized by the first compressor 24 and is supplied to the intake manifold 14 through the intake passage 30.

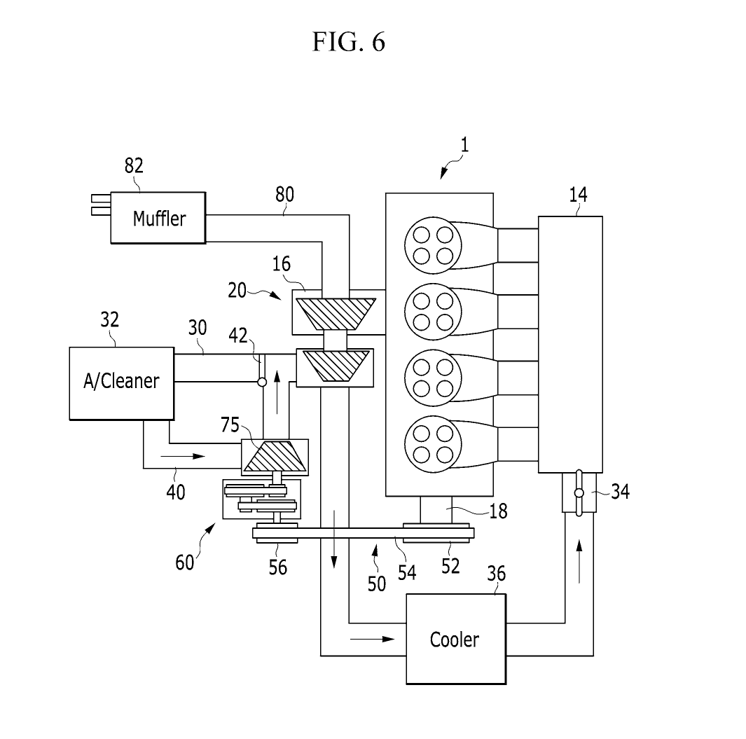

As shown in FIG. 6, when the engine 1 operates at the turbo lag region, the control portion 120 controls the clutch 58 to connect the power delivery device 60 to the driving means 50 and controls the control valve 42 to communicate the bypass passage 40 with the intake passage 30. In this case, the air passing through the air cleaner 32 passes through the bypass passage 40 and is primarily pressurized by the second compressor 75. In addition, the air passes through the intake passage 30 downstream of the second point and is secondarily pressurized by the first compressor 24. After that, the pressurized air is supplied to the intake manifold 14 through the intake passage 30. Therefore, the air amount supplied to the intake manifold 14 at the turbo lag region is increased.

Hereinafter, a system for correcting turbo lag according to various embodiments of the present inventions will be described in detail. In this specification, the same constituent elements are denoted by the same reference numerals.

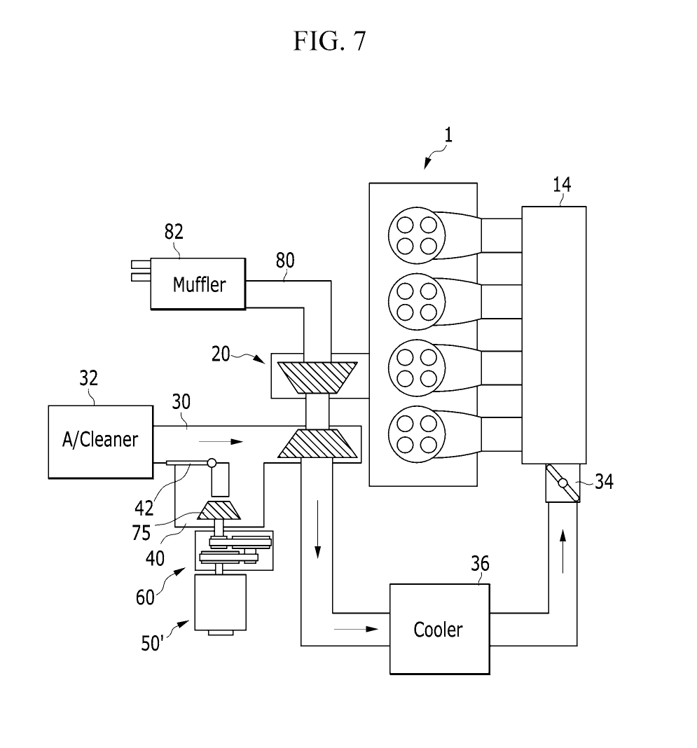

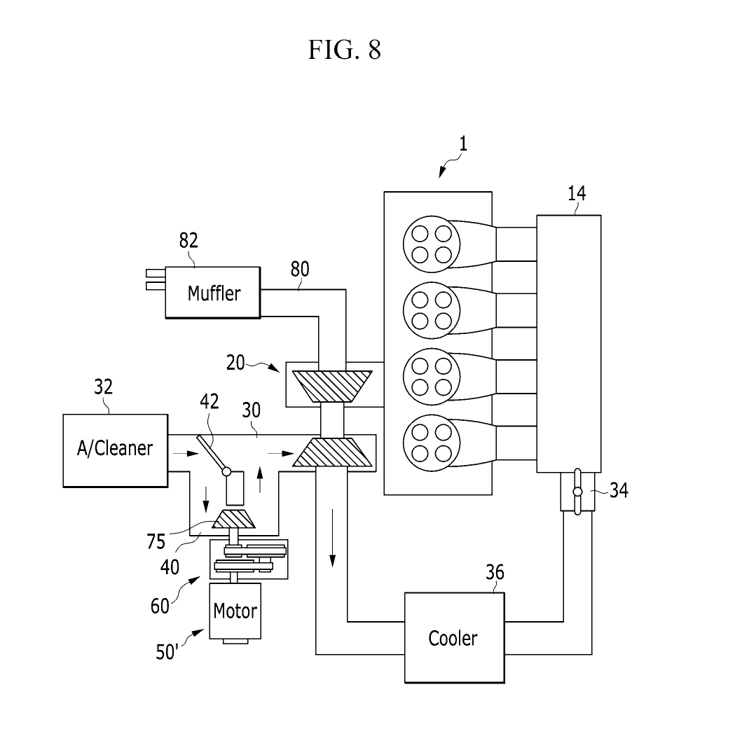

FIG. 7 and FIG. 8 are schematic diagrams of a system for correcting turbo lag according to various embodiments of the present invention. The system for correcting turbo lag according to the illustrated embodiment is similar to that described above except the positions of the driving means 50′ and the control valve 42. In the system for correcting turbo lag according to various embodiments of the present invention, a motor is used as the driving means 50′ and the control valve 42 is disposed at the first point.

As shown in FIG. 7, when the engine 1 operates at the normal state (i.e., the region which is not the turbo lag region), the control portion 120 prevents electricity from being supplied to the motor 50′ and controls the control valve 42 to block the bypass passage 40. In this case, since the bypass passage 40 is blocked, the air passing through the air cleaner 32 is pressurized by the first compressor 24 and is supplied to the intake manifold 14 through the intake passage 30.

As shown in FIG. 8, when the engine 1 operates at the turbo lag region, the control portion 120 supplies the electricity to the motor 50′ and controls the control valve 42 to communicate the bypass passage 40 with the intake passage 30. In this case, the air passing through the air cleaner 32 passes through the bypass passage 40 and is primarily pressurized by the second compressor 75. In addition, the air passes through the intake passage 30 downstream of the second point and is secondarily pressurized by the first compressor 24. After that, the pressurized air is supplied to the intake manifold 14 through the intake passage 30. Therefore, the air amount supplied to the intake manifold 14 at the turbo lag region is increased.

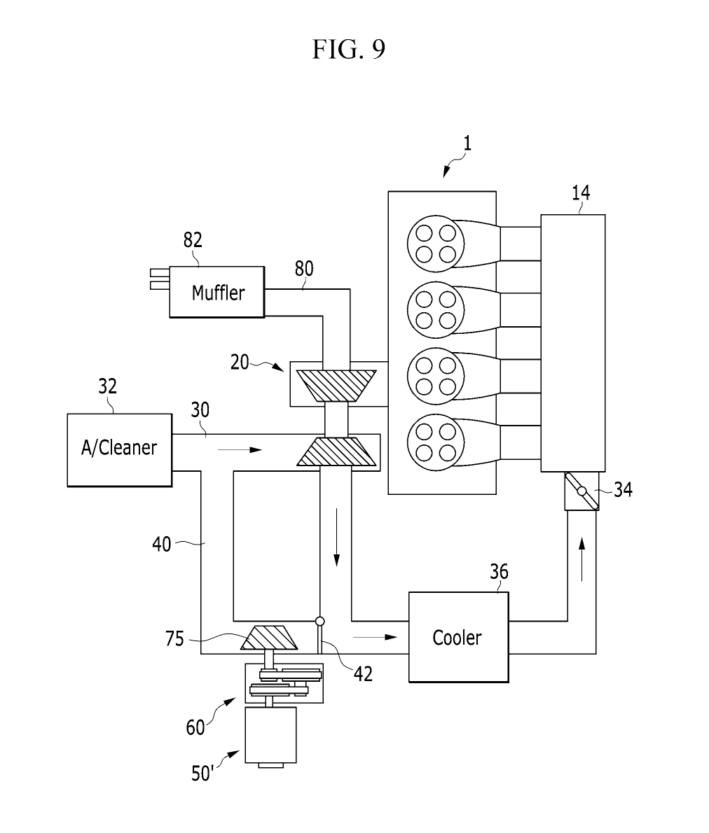

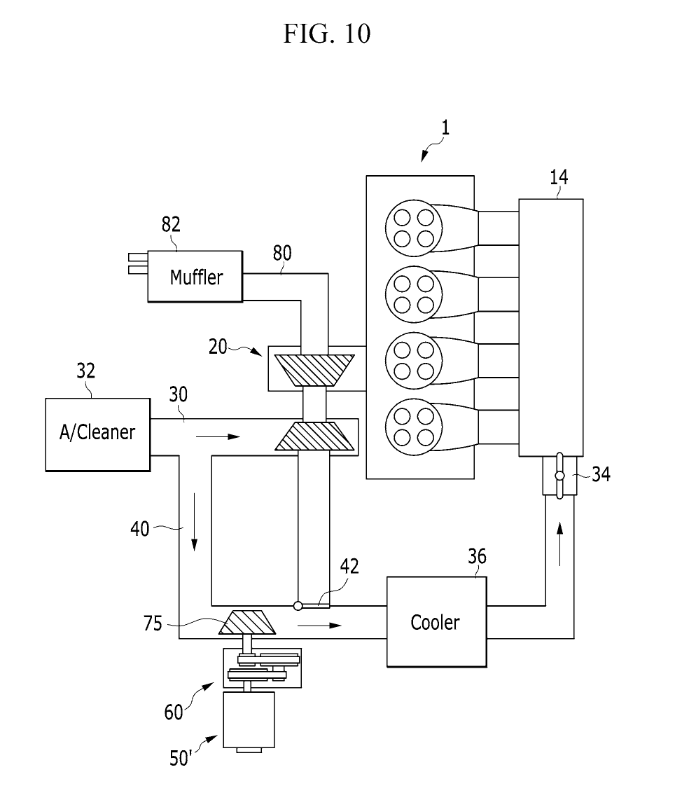

FIG. 9 and FIG. 10 are schematic diagrams of a system for correcting turbo lag according to various embodiments of the present invention. The system for correcting turbo lag according to this illustrated embodiment is similar to that shown in FIG. 7 and FIG. 8 except the positions of the second point and the control valve 42. In the system for correcting turbo lag according to various embodiments of the present invention, the motor is used as the driving means 50′, the second point is positioned at the intake passage 30 downstream of the turbo charger 20 (the first compressor 24), and the control valve 42 is disposed at the second point.

As shown in FIG. 9, when the engine 1 operates at the normal state (i.e., the region which is not the turbo lag region), the control portion 120 prevents electricity from being supplied to the motor 50′ and controls the control valve 42 to block the bypass passage 40. In this case, since the bypass passage 40 is blocked, the air passing through the air cleaner 32 is pressurized by the first compressor 24 and is supplied to the intake manifold 14 through the intake passage 30.

As shown in FIG. 10, when the engine 1 operates at the turbo lag region, the control portion 120 supplies the electricity to the motor 50′. At this time, since rotation speed of the second compressor 75 is faster than that of the first compressor 24, air pressure of the bypass passage 40 is higher than that of the intake passage 30 at the second point. Therefore, the control valve 42 blocks the intake passage 30 at the second point. In this case, the air passing through the air cleaner 32 passes through the bypass passage 40 and is primarily pressurized by the second compressor 75. In addition, the air passes through the intake passage 30 downstream of the second point and is supplied to the intake manifold 14.

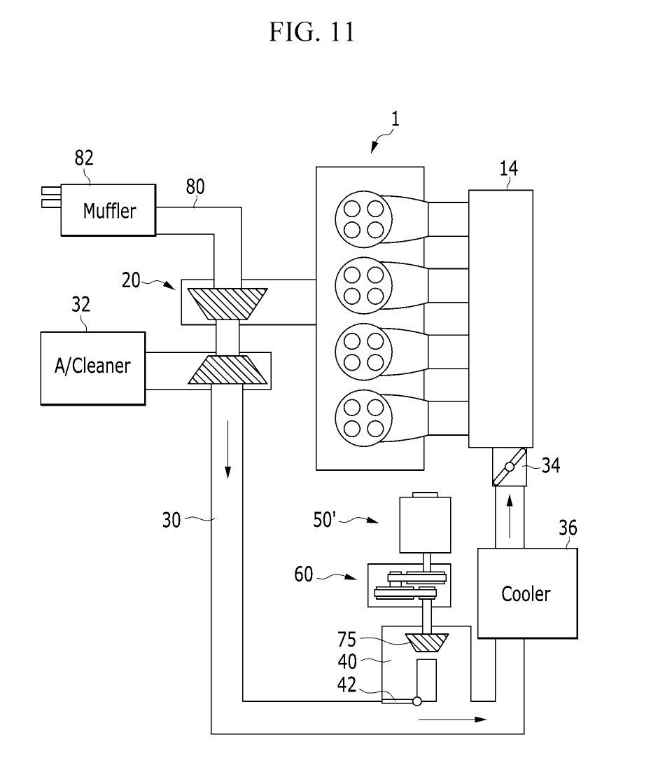

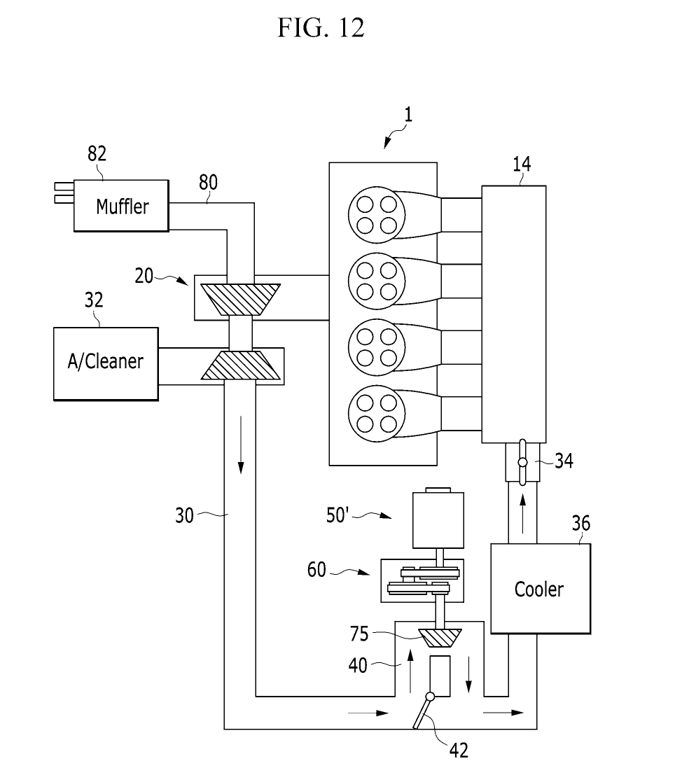

FIG. 11 and FIG. 12 are schematic diagrams of a system for correcting turbo lag according to various embodiments of the present invention. The system for correcting turbo lag according to the illustrated embodiment is similar to that shown in FIG. 7 and FIG. 8 except a position of the second point. In the system for correcting turbo lag according to such embodiments of the present invention, a motor is used as the driving means 50′, the control valve 42 is positioned at the first point, and the first and second points are positioned between the turbo charger 20 and the cooling apparatus 36 at the intake passage 30. Particularly, the first and second points and the cooling apparatus 36 are disposed closed to the intake manifold 14 such that boosting time may be shortened and capacity of the second compressor 75 may be minimized.

As shown in FIG. 11, when the engine 1 operates at the normal state, the control portion 120 prevents electricity from being supplied to the motor 50′ and controls the control valve 42 to block the bypass passage 40. In this case, since the bypass passage 40 is blocked, the air passing through the air cleaner 32 is pressurized by the first compressor 24 and is supplied to the intake manifold 14 through the intake passage 30.

As shown in FIG. 12, when the engine 1 operates at the turbo lag region, the control portion 120 supplies the electricity to the motor 50′ and controls the control valve 42 to communicate the bypass passage 40 with the intake passage 30. In this case, the air passing through the air cleaner 32 is primarily pressurized by the first compressor 24 and passes through the bypass passage 40. At this time, the air passing through the bypass passage 40 is secondarily pressurized by the second compressor 75. After that, the pressurized air is supplied to the intake manifold 14 through the intake passage 30.

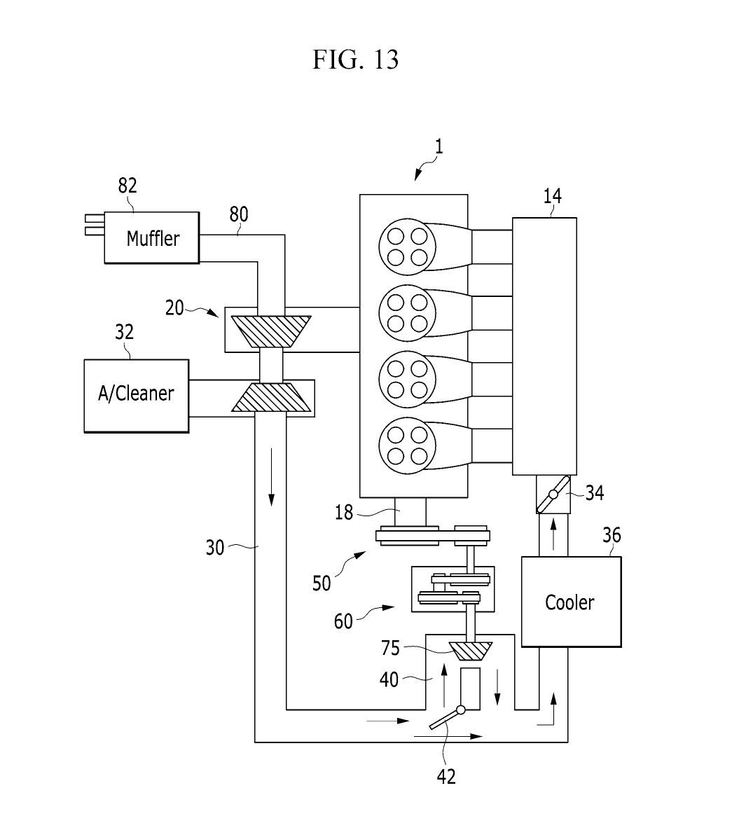

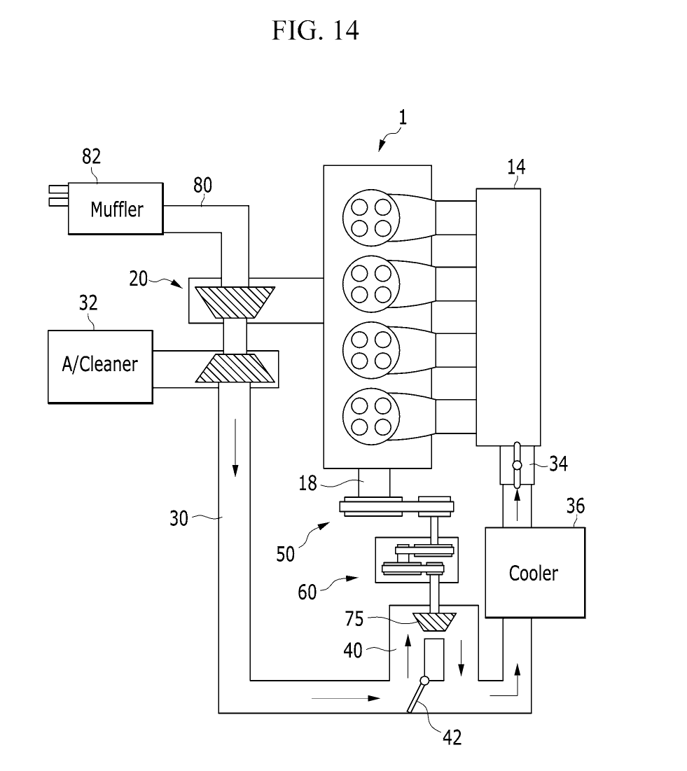

FIG. 13 and FIG. 14 are schematic diagrams of a system for correcting turbo lag according to various embodiments of the present invention. The system for correcting turbo lag according to the illustrated embodiment is similar to that shown in FIG. 11 and FIG. 12 except the driving means 50. In such systems, the driving means 50, as shown in FIG. 1, operates the second compressor 75 by using the power of the engine 1. Operation of the such embodiments is similar to that shown in FIG. 11 and FIG. 12, and thus detailed description thereof will be omitted.

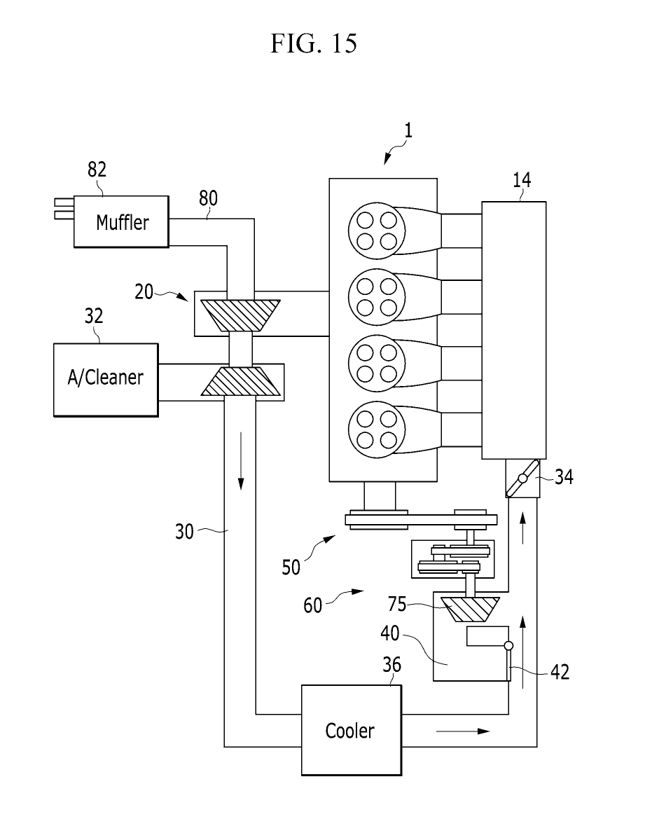

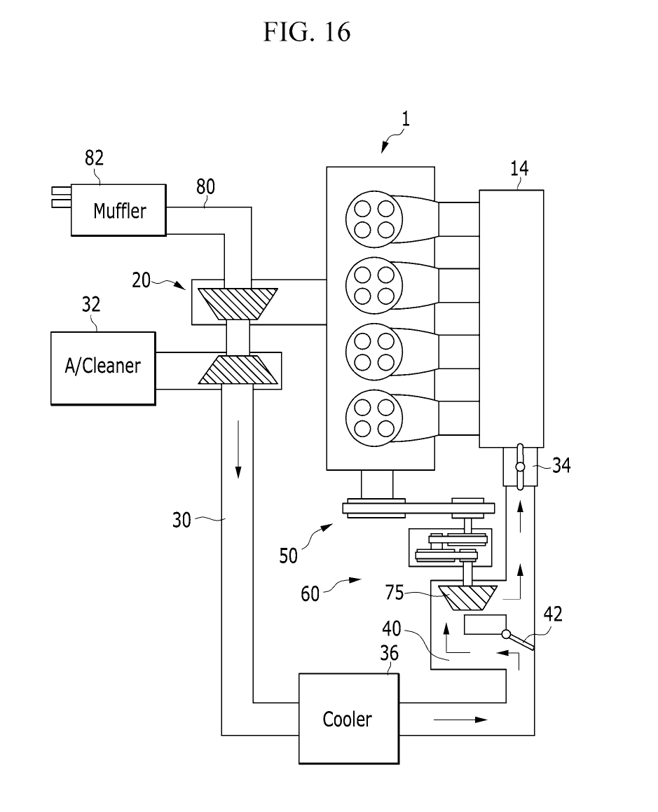

FIG. 15 and FIG. 16 are schematic diagrams of a system for correcting turbo lag according to various embodiments of the present invention. Such systems are similar to that shown in FIG. 13 and FIG. 14 except the positions of the first and second points. In such systems, the first and second points are positioned between the cooling apparatus 36 and the intake manifold 14. If the second compressor 75 is disposed as closest to the intake manifold 14 as possible, boosting time can be greatly shortened. Operation of such embodiments is similar to that of FIGS. 13 and 14, and thus detailed description thereof will be omitted.

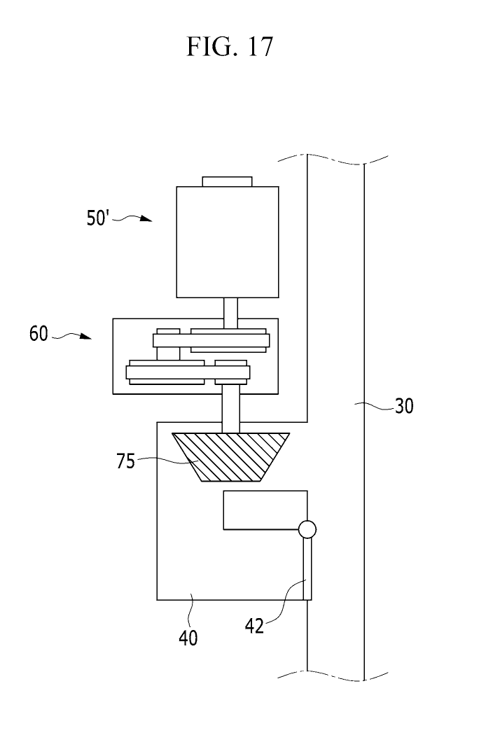

FIG. 17 is a schematic diagram of a system for correcting turbo lag according to various embodiments of the present invention. Such systems for correcting turbo lag are the same as those shown in FIG. 15 and FIG. 16 except the driving means 50′. In such systems, a motor is used as the driving means 50′. Operation of the illustrated embodiment is similar to that shown in FIG. 15 and FIG. 16, and thus detailed description thereof will be omitted.

As described above, an additional compressor is operated within a turbo lag region and acceleration performance may be improved according to the present invention.

Since air does not pass through the additional compressor if an engine is not operated at the turbo lag region, power loss may be reduced.

For convenience in explanation and accurate definition in the appended claims, the terms “upper” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A system for correcting turbo lag, comprising:
an engine includes a plurality of cylinders, an intake manifold for supplying air to the plurality of cylinders, and an exhaust manifold for exhausting exhaust gas generated in the plurality of cylinders;
an intake passage connected to the intake manifold to supply fresh air to the intake manifold;
an exhaust passage connected to the exhaust manifold to exhaust the exhaust gas gathered in the exhaust manifold;
a turbo charger includes a turbine mounted at the exhaust manifold or the exhaust passage and rotated by the exhaust gas and a first compressor mounted at the intake passage and connected to the turbine to rotate with the turbine and compress the air of the intake passage;
a bypass passage branching off at a first point of the intake passage and joining the intake passage at a second point of the intake passage downstream of the first point;
a second compressor mounted at the bypass passage and compressing the air passing through the bypass passage; and
driving means generating power for operating the second compressor and selectively supplying the power to the second compressor through a power delivery device.

2. The system of claim 1, wherein the power delivery device comprises a plurality of pulleys and at least one of belts and shafts connecting each pulley to the second compressor, the driving means, or other pulley.

3. The system of claim 1, wherein the second compressor is operated at a predetermined turbo lag region.

4. The system of claim 1, further comprising a control valve selectively communicating the bypass passage to the intake passage.

5. The system of claim 4, wherein the control valve opens or closes automatically by a difference between air pressure of the intake passage and air pressure of the bypass passage near a mounting portion thereof.

6. The system of claim 1, wherein the belt is a flat belt.

7. The system of claim 1, wherein a cooling apparatus for cooling the air is mounted at the intake passage downstream of the turbo charger.

8. The system of claim 7, wherein the first point and the second point are positioned at the intake passage upstream of the turbo charger.

9. The system of claim 8, wherein the driving means comprises:
a crankshaft pulley mounted at a crankshaft of the engine and rotating with the crankshaft;
a driving pulley connected to the crankshaft pulley through a driving belt; and
a clutch selectively connecting the power delivery device to the driving pulley to selectively transmit the power of the driving means.

10. The system of claim 8, wherein the driving means is a motor connected to the power delivery device and selectively generating the power supplied to the second compressor.

11. The system of claim 7, wherein the first point is positioned at the intake passage upstream of the turbo charger and the second point is positioned between the turbo charger of the intake passage and the cooling apparatus.

12. The system of claim 11, wherein the driving means comprises:
a crankshaft pulley mounted at a crankshaft of the engine and rotating with the crankshaft;
a driving pulley connected to the crankshaft pulley through a driving belt; and
a clutch selectively connecting the power delivery device to the driving pulley to selectively transmit the power of the driving means.

13. The system of claim 11, wherein the driving means is a motor connected to the power delivery device and selectively generating the power supplied to the second compressor.

14. The system of claim 7, wherein the first point and the second point are positioned between the turbo charger at the intake passage and the cooling apparatus.

15. The system of claim 14, wherein the driving means comprises:
a crankshaft pulley mounted at a crankshaft of the engine and rotating with the crankshaft;
a driving pulley connected to the crankshaft pulley through a driving belt; and
a clutch selectively connecting the power delivery device to the driving pulley to selectively transmit the power of the driving means.

16. The system of claim 14, wherein the driving means is a motor connected to the power delivery device and selectively generating the power supplied to the second compressor.

17. The system of claim 7, wherein the first point and the second point are positioned at the intake passage downstream of the cooling apparatus.

18. The system of claim 17, wherein the driving means comprises:
a crankshaft pulley mounted at a crankshaft of the engine and rotating with the crankshaft;
a driving pulley connected to the crankshaft pulley through a driving belt; and
a clutch selectively connecting the power delivery device to the driving pulley to selectively transmit the power of the driving means.

19. The system of claim 17, wherein the driving means is a motor connected to the power delivery device and selectively generating the power supplied to the second compressor.

20. A system for correcting turbo lag which increases air amount supplied to an engine at a predetermined turbo lag region, comprising:
an intake passage for supplying the air to the engine;
an exhaust passage for exhausting an exhaust gas generated in the engine to the exterior;
a turbo charger disposed between the intake passage and the exhaust passage and pressurizing the air by using energy of the exhaust gas;
a bypass passage disposed in parallel with the intake passage at some region of the intake passage;
a control valve selectively communicating the bypass passage with the intake passage at the predetermined turbo lag region; and
a compressor operating at the turbo lag region to pressurize the air passing through the bypass passage and to supply the pressurized air to the intake passage.
